(19) United States
(12) Patent Application Publication
(10) Pub. No.: US 2026/0230767 A1
(43) Pub. Date: Aug. 6, 2026

(54) ELECTRONIC DEVICE FOR GENERATING OR PLAYING BACK AUDIO SIGNAL, AND OPERATING METHOD THEREOF

(71) Applicant: Samsung Electronics Co., Ltd., Suwon-si (KR)

(72) Inventors: Hyunchul YANG, Suwon-si (KR); Seung HEO, Suwon-si (KR); Hyunwook KIM, Suwon-si (KR); Hangil MOON, Suwon-si (KR); Jaeha PARK, Suwon-si (KR); Kyoungho BANG, Suwon-si (KR); Soonho BAEK, Suwon-si (KR)

(21) Appl. No.: 19/634,732

(22) Filed: Mar. 31, 2026

Related U.S. Application Data
(63) Continuation of application No. PCT/KR2024/016316, filed on Oct. 24, 2024.

(30) Foreign Application Priority Data
Nov. 7, 2023 (KR) 10-2023-0152436
Dec. 21, 2023 (KR) 10-2023-0188172

(51) Int. Cl. H04S 7/00

(52) U.S. Cl. CPC H04S 7/301; H04S 2420/01

(57) ABSTRACT

An electronic device is provided. The electronic device includes a communication circuit, memory, comprising one or more storage media, storing instructions, and one or more processors communicatively coupled to the communication circuit and the memory, wherein the instructions, when executed by the one or more processors individually or collectively, cause the electronic device to receive, through the communication circuit, two or more pieces of audio data simultaneously acquired by one or more external electronic devices, identify user individual head-related transfer function (HRTF) information acquired based on reference HRTF information by using user information acquired from the memory, based on the two or more pieces of audio data, identify sound source generation location information of the two or more pieces of audio data, generate an audio signal by performing inverse filtering of the two or more pieces of audio data, based on the user individual HRTF information, and transmit the audio signal and the sound source generation location information to another electronic device through the communication circuit.

### CROSS-REFERENCE TO RELATED APPLICATION(S)

This application is a continuation application, claiming priority under 35 U.S.C. § 365 (c), of an International application No. PCT/KR2024/016316, filed on Oct. 24, 2024, which is based on and claims the benefit of a Korean patent application number 10-2023-0152436, filed on Nov. 7, 2023, in the Ministry of Intellectual Property (MOIP), and of a Korean patent application number 10-2023-0188172, filed on Dec. 21, 2023, in the Ministry of Intellectual Property (MOIP), the disclosure of each of which is incorporated by reference herein in its entirety.

### BACKGROUND

### 1. Field

The disclosure relates to an electronic device for generating or reproducing an audio signal and a method for operating the same.

### 2. Description of Related Art

Various electronic devices such as a smartphone, a tablet personal computer (PC), a portable multimedia player (PMP), a personal digital assistant (PDA), a laptop personal computer (PC), or a wearable device are being distributed.

An electronic device may output sound data by using wearable electronic devices, such as earphones or a headset. The electronic device may be connected to earphones or a headset via a wireless communication method (e.g., Bluetooth), and may transmit sound data to the earphones or headset or receive external sound data acquired through a microphone installed in the earphones or headset.

The above information is presented as background information only to assist with an understanding of the disclosure. No determination has been made, and no assertion is made, as to whether any of the above might be applicable as prior art with regard to the disclosure.

### SUMMARY

When an external sound source is input through microphones installed in a wearable electronic devices, such as earphones or a headset worn on both ears of a user, and recorded as audio data, various characteristics of the user wearing the wearable electronic device, such as a face shape and/or ear shape of the user, may be reflected in the audio data.

In a case where audio data reflecting various characteristics of a user is reproduced by another user, a face shape and/or an ear shape of the other user may be different from those of the user, and thus it may be difficult for the user to feel a sense of presence directly experienced by the user.

Aspects of the disclosure are to address at least the above-mentioned problems and/or disadvantages and to provide at least the advantages described below. Accordingly, an aspect of the disclosure is to provide an electronic device configured to control a wearable electronic device so that external sound is introduced into or not introduced into the wearable electronic device according to an operation state of the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit, memory, comprising one or more storage media, storing instructions, and one or more processors communicatively coupled to the communication circuit and the memory, wherein the instructions, when executed by the one or more processors individually or collectively, cause the electronic device to receive, through the communication circuit, two or more pieces of audio data simultaneously acquired by one or more external electronic devices, identify user individual head-related transfer function (HRTF) information acquired based on reference HRTF information by using user information acquired from the memory, based on the two or more pieces of audio data, identify sound source generation location information of the two or more pieces of audio data, generate an audio signal by performing inverse filtering of the two or more pieces of audio data, based on the user individual HRTF information, and transmit the audio signal and the sound source generation location information to another electronic device through the communication circuit.

In accordance with another aspect of the disclosure, a method performed by an electronic device is provided. The method includes receiving, by the electronic device, two or more pieces of audio data simultaneously acquired by one or more external electronic devices, identifying, by the electronic device, user individual head-related transfer function (HRTF) information acquired based on reference HRTF information by using user information, based on the two or more pieces of audio data, identifying, by the electronic device, sound source generation location information of the two or more pieces of audio data, generating, by the electronic device, an audio signal by performing inverse filtering of the two or more pieces of audio data, based on the user individual HRTF information, and transmitting, by the electronic device, the audio signal and the sound source generation location information to another electronic device.

In accordance with another aspect of the disclosure, an electronic device is provided. The electronic device includes a communication circuit, memory, comprising one or more storage media, storing instructions, and one or more processors communicatively coupled to the communication circuit and the memory, wherein the instructions, when executed by the one or more processors individually or collectively, cause the electronic device to receive, through the communication circuit, a binaural audio signal and sound source generation location information of the binaural of the audio signal from another electronic device, identify user individual head-related transfer function (HRTF) information acquired based on reference HRTF information by using user information acquired from the memory, generate two pieces of audio data by applying the user individual HRTF information and the sound source generation location information to the binaural audio signal, and transmit the two pieces of audio data to one or more external electronic devices so as to reproduce the two pieces of audio data by the one or more external electronic devices.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, two or more pieces of audio data simultaneously acquired by one or more external electronic devices, identifying, by the electronic device, user individual head-related transfer function (HRTF) information acquired based on reference HRTF information by using user information, based on the two or more pieces of audio data, identifying, by the electronic device, sound source generation location information of the two or more pieces of audio data, generating, by the electronic device, an audio signal by performing inverse filtering of the two or more pieces of audio data, based on the user individual HRTF information, and transmitting, by the electronic device, the audio signal and the sound source generation location information to another electronic device.

According to various embodiments, an audio signal is generated by removing various characteristics of a user wearing an earphone and/or a headset from audio data that is recorded from an external sound source through a wearable device such as an earphone and/or a headset.

According to various embodiments, by generating and reproducing audio data in which information regarding an external sound source and various characteristics of a user are reflected in an audio signal, a sense of presence is provided through reproduced sound.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a configuration diagram of an electronic device and an external electronic device (e.g., an earphone) according to an embodiment of the disclosure;

FIG. 3 is a block diagram of an external electronic device according to an embodiment of the disclosure;

FIG. 4 illustrates an exterior of an external electronic device according to an embodiment of the disclosure;

FIG. 5 is a flowchart illustrating an audio signal generation operation of an electronic device according to an embodiment of the disclosure;

FIG. 6 is a flowchart illustrating an audio signal reproduction operation of an electronic device according to an embodiment of the disclosure;

FIG. 7 illustrates an operation of identifying or applying sound source location information in an electronic device according to an embodiment of the disclosure; and

FIGS. 8, 9, and 10 illustrate an operation of identifying or applying sound source location information in an electronic device according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

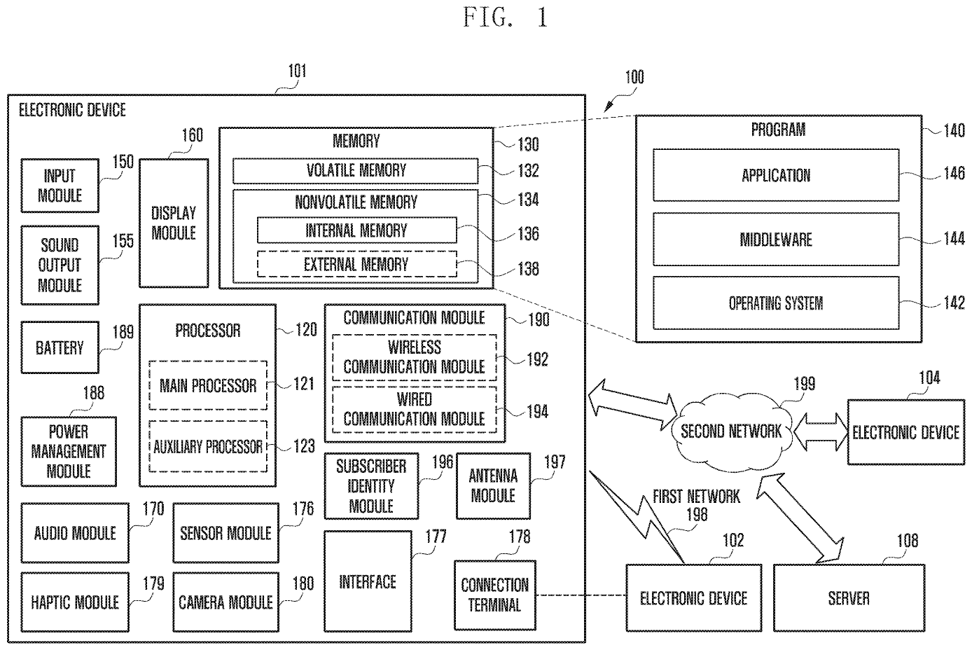

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or use plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

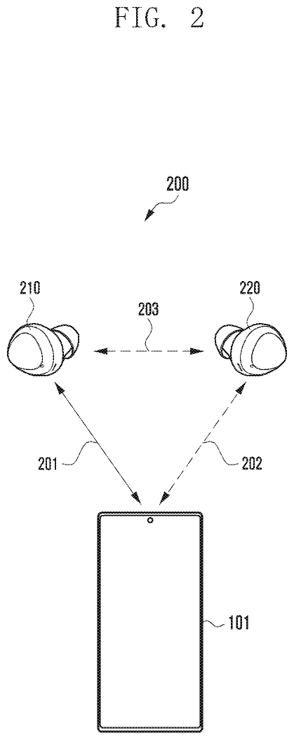

FIG. 2 is a configuration diagram of an electronic device (e.g., the electronic device 101 in FIG. 1) and an external electronic device (e.g., the electronic device 102 in FIG. 1) according to an embodiment of the disclosure.

Referring to FIG. 2, in a configuration diagram 200, an external electronic device 210 and/or 220 may include one or more electronic devices, such as a first external electronic device 210 and a second external electronic device 220. For example, an external electronic device 210 and/or 220 may include headphones, earphones, and/or earbuds that are wearable by a user and capable of providing sound to the user based on audio data received from the electronic device 101 through a communication function. Hereinafter, an example will be described in which a first external electronic device 210 and a second external electronic device 220 included in the external electronic devices 210 and/or 220 are implemented as earbuds wearable on a left ear and a right ear of a user, respectively. However, various embodiments are not limited thereto.

The electronic device 101 may be a portable and/or mobile electronic device, such as a smartphone, a tablet PC, a portable multimedia player (PMP), a personal digital assistant (PDA), a laptop PC, and a wearable device.

According to an embodiment, the electronic device 101 may be an electronic device capable of generating or reproducing music or images, and may generate an audio signal by receiving audio data from the external electronic devices 210 and/or 220 or reproduce the audio data by transmitting the audio data to the external electronic devices 210 and/or 220.

For example, the electronic device 101 may be an electronic device capable of generating music or images, and may receive audio data from each of the external electronic devices 210 and 220, process the received audio data, and generate an audio signal from which binaural sound can be restored. For example, the electronic device 101 may process audio data received from the external electronic devices 210 and 220 to generate an audio signal which has been equalized by cancelling or reducing, from the audio data, an influence caused by wearing of the external electronic device by a user of the electronic device 101, and may transmit the generated audio signal to another electronic device (or referred to as a second electronic device) (e.g., the electronic devices 102, 104, or 108 in FIG. 1).

For example, the electronic device 101 may process an audio signal received from another electronic device (e.g., the electronic devices 102, 104, or 108 in FIG. 1) to generate audio data, and transmit the generated audio data to the external electronic devices 210 and/or 220 so that the audio data are reproduced. The generated audio data may be binaural audio data capable of restoring binaural sound through two different pieces of audio data, for example. The two different pieces of audio data may be transmitted to the first external electronic device 210 and the second external electronic device 220, respectively, and reproduced, thereby restoring binaural sound.

According to various embodiments, the external electronic devices 210 and/or 220 may be connected to the electronic device 101 via wireless communication. For example, the electronic device 101 may communicate with the first external electronic device 210 by using a first communication link 201 (e.g., the first network 198 in FIG. 1) including a short-range communication network, such as Bluetooth (or BLE), Wi-Fi direct, or infrared data association (IrDA). For example, the electronic device 101 may communicate with a second external electronic device 220 by using a second communication link 202 (e.g., the first network 198 in FIG. 1) including a short-range communication network such as Bluetooth (or BLE), Wi-Fi direct, or infrared data association (IrDA).

According to an embodiment, the first external electronic device 210 and the second external electronic device 220 may be implemented as earphones, and the two devices may operate while being independently connected to the electronic device 101, or one of the two devices may operate as a primary earbud (or primary equipment) (PE) and the other may operate as a secondary earbud (or secondary equipment) (SE). For example, in a case where the first external electronic device 210 and the second external electronic device 220 are independently connected to and communicate with the electronic device 101, the first external electronic device 210 and the second external electronic device 220 may transmit and receive data to and from the electronic device 101 through the first communication link 201 and the second communication link 202, respectively. For example, when the first external electronic device 210 operates as a primary earbud and communicates with the electronic device 101 through the first communication link 201, the second external electronic device 220 may perform sniffing on the first communication link 201 as a secondary earbud to acquire data transmitted from the electronic device 101 to the first external electronic device 210. Meanwhile, the first external electronic device 210 and the second external electronic device 220 may form a third communication link 203 and may transmit and receive data through the third communication link 203.

Hereinafter, an example will be described in which the electronic device 101 communicates with the first external electronic device 210 through the first communication link 201 and also communicates with the second external electronic device 220 through the first communication link 201. However, various embodiments are not limited thereto, and the electronic device 101 may communicate with the first external electronic device 210 and the second external electronic device 220 through an independent first communication link 201 and an independent second communication link 202, respectively (e.g., the first network 198 in FIG. 1).

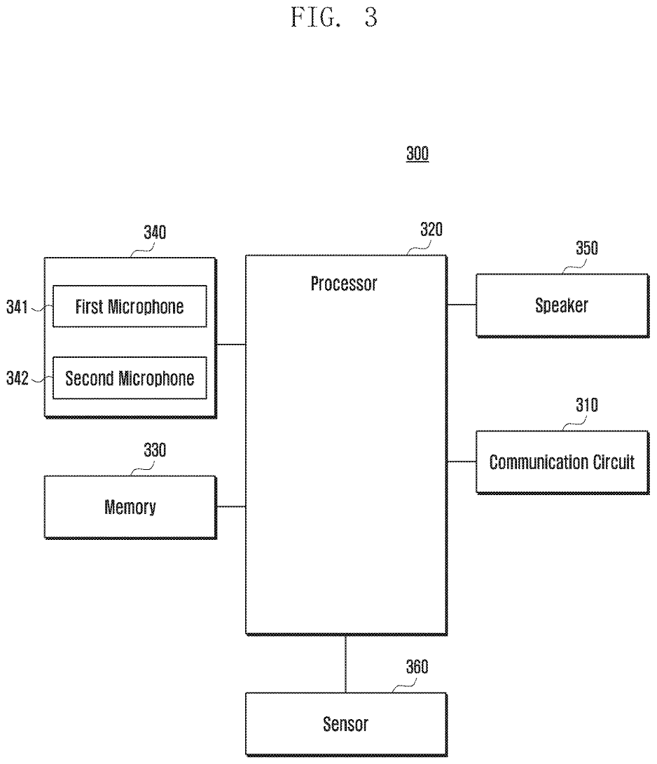

FIG. 3 is a block diagram of an external electronic device (e.g., the first external electronic device 210 or the second external electronic device 220 in FIG. 2) according to an embodiment of the disclosure.

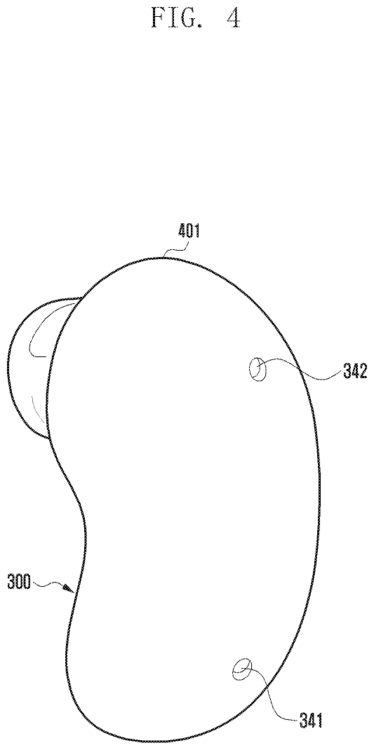

FIG. 4 illustrates an exterior of an external electronic device 300 according to an embodiment of the disclosure.

Referring to FIG. 3, an external electronic device 300 may include a communication circuit 310, a processor 320, memory 330, a microphone 340, a speaker 350, and a sensor 360. The elements included in FIG. 3 are only some of the elements included in the external electronic device 300, and the external electronic device 300 may further include various elements (e.g., a power management circuit and/or a battery).

The processor 320 may execute software (e.g., a program) to process control commands and/or audio data received from an electronic device (e.g., the electronic device 101 in FIG. 2) connected through the communication circuit 310, and may store, in the memory 330, information according to processing results or information generated according to operations of various elements, or transmit the information to the electronic device. To this end, the processor 320 may control at least one other element (e.g., a hardware or software element) of the external electronic device 300 and perform various data processing or operations.

The memory 330 may store various data used by at least one element (e.g., the processor 320 or the sensor 360) of the external electronic device 300. The data may include, for example, software (e.g., a program) and input data or output data related to commands associated the software. The memory 330 may include volatile memory or non-volatile memory.

According to an embodiment, as at least a part of data processing or computation, the processor 320 may load a command or data received from other elements (e.g., the sensor 360 or the communication circuit 310) to the volatile memory, process the command or data loaded in the volatile memory, and store result data in the non-volatile memory.

The communication circuit 310 may support establishment of a communication channel through a communication link (e.g., a first communication link 201 or a second communication link 202) between the external electronic device 300 and the electronic device 101 and/or communication through the established communication channel. The communication circuit 310 may support establishment of a communication channel through a communication link (e.g., a third communication link 203) with other external electronic devices (e.g., a second external electronic device 220 or a first external electronic device 210) and/or communication through the established communication channel.

According to an embodiment, the communication circuit 310 may include a wireless communication module (e.g., a cellular communication module, a short-range wireless communication module, or a global navigation satellite system (GNSS) communication module) or a wired communication module.

According to an embodiment, the communication circuit 310 may communicate with the electronic device 101 through a first communication link 201 or a second communication link 202 (e.g., a short-range wireless communication network such as Bluetooth, Wi-Fi direct, or an infrared data association (IrDA)).

According to an embodiment, the communication circuit 310 may communicate with other external electronic devices (e.g., the second external electronic device 220 or the first external electronic device 210) through a third communication link 203 (e.g., a short-range wireless communication network, such as Bluetooth, Wi-Fi direct, or infrared data association (IrDA)).

The communication circuit 310 may include an antenna module. The antenna module of the communication circuit 310 may transmit a signal and/or power to an external device (e.g., the electronic device 101) or receive the signal and/or power therefrom. According to an embodiment, the antenna module of the communication circuit 310 may include one antenna including a radiator formed of a conductor or a conductive pattern formed on a substrate (e.g., PCB).

According to an embodiment, the antenna module may include multiple antennas. In this case, among the multiple antennas, at least one antenna suitable for a communication scheme used in a wireless communication network such as the first communication link 201, the second communication link 202, and/or the third communication link 203 may be selected by the communication circuit 310. A signal or power may be transmitted or received between the communication circuit 310 and the electronic device 101 through the at least one selected antenna. According to an embodiment, in addition to the radiator, another component (e.g., an RFIC) may be additionally formed as a part of the antenna module.

The sensor 360 may include a contact or grip sensor, an acceleration sensor, a geomagnetic sensor, and/or a gyroscope sensor. The contact or grip sensor may detect that the external electronic device 300 is in contact with a user's ear for at least a designated time and/or at least a designated intensity, and transmit a sensor signal to the processor 320. The acceleration sensor, the geomagnetic sensor, and/or the gyroscope sensor may detect the movement and/or inertia of the external electronic device 300. The acceleration sensor and/or the gyroscope sensor may include a circuit (e.g., an integrated circuit (IC)) for controlling the operation of the acceleration sensor and/or the gyroscope sensor. For example, a circuit (e.g., an integrated circuit (IC)) for controlling the operation of the acceleration sensor and/or the gyroscope may be included in the external electronic device 300 and may be implemented as the processor 320.

According to an embodiment, the speaker 350 may output an audio signal to the outside of the external electronic device 300. The processor 320 may output, as sound through the speaker 350, an electrical signal (audio signal) processed based on audio data received from the electronic device 101 connected wirelessly thereto.

According to an embodiment, the microphone 340 may convert sound acquired from the outside to an electric signal to generate audio data. A sound entering the microphone 340 may include, for example, a sound generated in an external environment of a user in case that the external electronic device 300 is worn. The microphone 340 may be implemented to include multiple microphones (e.g., a first microphone 341 and a second microphone 342).

Referring to FIG. 4, in a case where the external electronic device 300 is implemented to include a plurality of microphones including a first microphone 341 and a second microphone 342, the first microphone 341 and the second microphone 342 may be spaced apart from each other by a designated distance and disposed at different positions in the housing 401 of the external electronic device 300. Accordingly, sound introduced into the first microphone 341 and sound introduced into the second microphone 342 may have different frequency latencies and/or levels (e.g., decibels (dB)) depending on a generation location of the external sound source.

According to an embodiment, the processor 320 may transmit one or more pieces of audio data acquired through the microphone 340 to the electronic device 101. The processor may process audio data received from the electronic device 101 and output the processed audio data through the speaker 350.

Although not illustrated, the external electronic device 300 may include a battery for supplying power required for each element. The external electronic device 300 may further include a power management circuit (not illustrated) configured to control the charging of the battery and manage the power supplied to each element, by using the power supplied from the external power source. The battery may include, for example, a non-rechargeable primary battery, a rechargeable secondary battery, and/or a fuel cell.

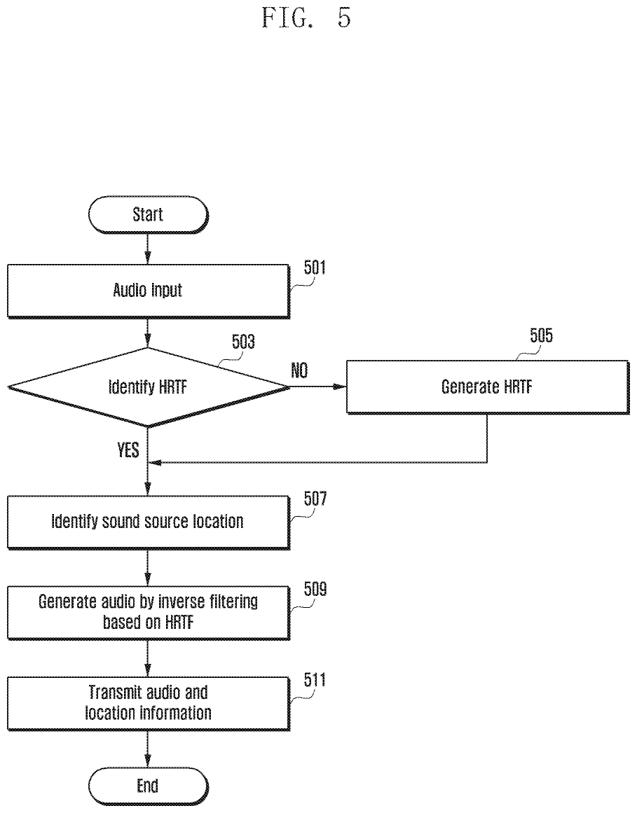

FIG. 5 is a flowchart illustrating an audio signal generation operation of an electronic device (e.g., the electronic device 101 in FIG. 1 or 2) according to an embodiment of the disclosure.

Referring to FIG. 5, in operation 501, a processor (e.g., the processor 120 in FIG. 1) of the electronic device 101 may receive audio data generated by one or more external electronic devices 300 (e.g., the first external electronic device 210 and/or the second external electronic device 220 in FIG. 2) through a communication circuit (e.g., the communication module 190 in FIG. 1).

According to various embodiments, the electronic device 101 may be a portable and/or mobile electronic device, such as a smartphone, a tablet PC, a portable multimedia player (PMP), a personal digital assistant (PDA), a laptop PC, and a wearable device.

According to various embodiments, the electronic device 101 may be connected to an external electronic device 300 by using a short-range wireless communication network, such as Bluetooth (or BLE), Wi-Fi direct, or infrared data association (IrDA), to receive audio data or transmit various types of control information including control commands.

According to an embodiment, the first external electronic device 210 and the second external electronic device 220, which are external electronic devices 300, may include headphones, earphones, and/or earbuds that may be worn on left and right ears of a user, respectively.

The processor 120 may receive, in real time, audio data generated respectively by the first external electronic device 210 and the second external electronic device 220. For example, the processor 120 may receive, from the memory (e.g., the memory 130 in FIG. 1), audio data acquired respectively by the first external electronic device 210 and the second external electronic device 220. The audio data may include audio data acquired respectively through microphones of the first external electronic device 210 and the second external electronic device 220 (e.g., the first microphone 341 and/or the second microphone 342 in FIG. 3). For example, in a state where the first external electronic device 210 is worn on a left ear of a user and the second external electronic device 220 is worn on a right ear of the user, the audio data may be acquired simultaneously. The audio data may include one or more pieces of first audio data acquired from one or more microphones of the first external electronic device 210 and one or more pieces of second audio data acquired from one or more microphones of the second external electronic device 220.

In operation 503, the processor 120 may identify user individual head-related transfer function (HRTF) information. For example, the user individual HRTF information may be stored in the memory 130.

When the user individual HRTF information cannot be identified, the processor 120 may generate the user individual HRTF information in operation 505. Operation 505 may be implemented to be performed in advance, and the user individual HRTF information generated accordingly may be stored in the memory 130.

The HRTF information may include a value obtained by modeling, in a frequency domain, a system in which a person perceives external sound through two ears. For example, by converting the HRTF information into a time domain to generate a head-related impulse response (HRIR) value and applying the HRIR value respectively to a mono sound source, audio data to be transferred to the left and right ears of a person may be generated, thereby enabling perception of binaural sound. HRTF information according to various user conditions may be configured as an HRTF database and stored in the memory 130. The HRTF database may classify and store HRTF information of various users, based on user information such as nationality, age, gender, and information regarding a head, a face, and/or an ear. The HRTF database may store, for each of the classifications, for example, an impulse response value according to a directional angle (e.g., an elevation angle and/or an azimuth angle).

The processor 120 may acquire, from the memory 130, user information such as personal information including nationality, age, and gender of a user, and information regarding a face or a head and/or an ear. For example, the processor 120 may extract various pieces of information, such as depth information, from user face image data acquired through an image sensor or camera (e.g., the camera module 180 in FIG. 1), and may determine, based on the extracted information, information regarding the user's face and/or ears, such as head size, face width or horizontal length, a distance between both ears, and/or a position or shape of the ears.

According to an embodiment, the processor 120 may extract a user individual HRTF through comparison with reference HRTF information stored in the HRTF database based on the acquired user information, and may use the extracted HRTF as the user individual HRTF information.

According to an embodiment, the processor 120 may further correct the user individual HRTF acquired from the HRTF database, and may use the corrected HRTF as the user individual HRTF information. For example, the processor 120 may generate a designated diagnostic sound through its own speaker (e.g., the sound output module 155 in FIG. 1), receive diagnostic sound audio data by causing the generated diagnostic sound to be acquired through the microphones of the first external electronic device 210 and the second external electronic device 220, and, based on the user information, analyze the diagnostic sound audio data to derive HRTF information. The processor 120 may correct the user individual HRTF extracted from the HRTF database, based on the derived HRTF information, and may use the corrected HRTF as the user individual HRTF information.

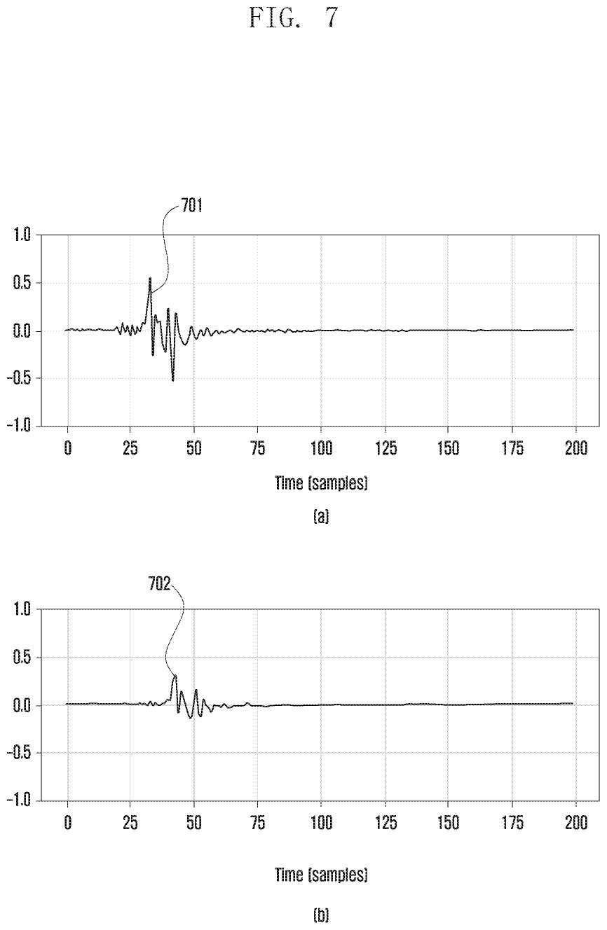

In operation 507, the processor 120 may identify a location of a sound source that has generated the input audio data, based on the input audio data. The processor 120 may identify a location of a sound source that has generated the audio data, based on two or more pieces of audio data, that is, first audio data and second audio data acquired respectively from the first external electronic device 210 and the second external electronic device 220. For example, the processor 320 may identify the location of the sound source, based on a time difference (interaural time difference) (e.g., a frequency latency difference) and/or a level difference (interaural level difference) (e.g., a decibel difference) of audio data received respectively from the external electronic device 300 (e.g., the first external electronic device 210 in FIG. 2) worn on a left ear of a user and the external electronic device (e.g., the second external electronic device 220 in FIG. 2) worn on a right ear of the user. A method for identifying the sound source location will be described in more detail below with reference to FIGS. 7 to 10.

In operation 509, the processor 120 may generate an audio signal which has been equalized by cancelling or reducing the influence of the user individual HRTF on the input audio data, using the user individual HRTF information.

The processor 120 may perform inverse filtering on the input audio data, based on the user individual HRTF information, or perform other audio signal processing methods on the input audio data.

The user individual HRTF information may be expressed as values of matrix A to include left and right HRTF values as given in Equation 1 below, and in this case, an inverse filter for performing inverse filtering may be expressed as values of inverse matrix A⁻¹ as given in Equation 2 below.

$$A = [ \begin{matrix}a & b \\ c & d\end{matrix} ] \qquad Equation 1$$

$${A}^{- 1} = \frac{1}{ad - bc} [ \begin{matrix}d & - b \\ - c & a\end{matrix} ] \qquad Equation 2$$

In operation 511, the processor 120 may transmit the generated audio signal, together with the sound source location information, to other electronic devices (e.g., the electronic devices 102, 104, or 108 in FIG. 1) through the communication circuit (e.g., the communication module 190 in FIG. 1).

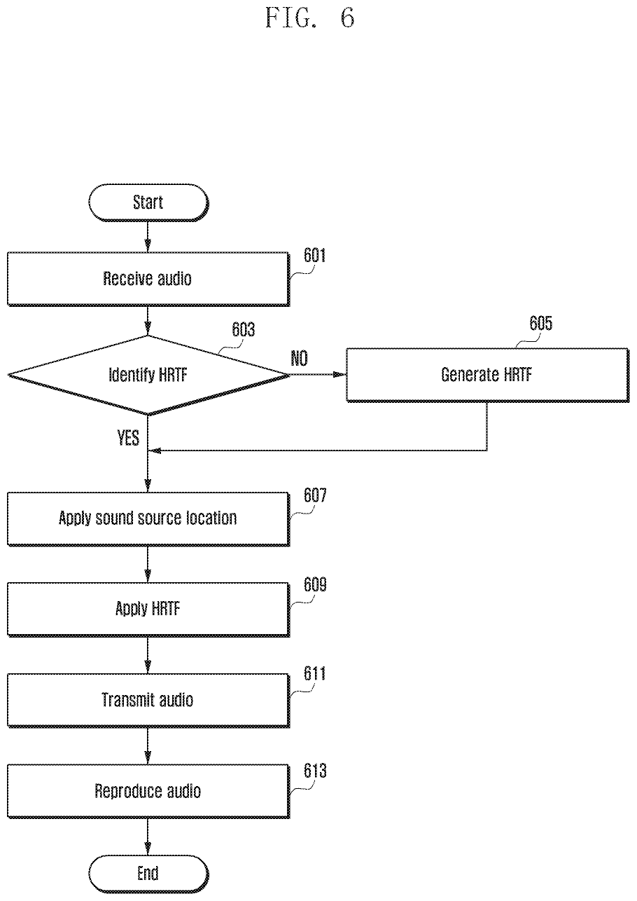

FIG. 6 is a flowchart illustrating an audio signal reproduction operation of an electronic device (e.g., the electronic device 101 in FIG. 1 or 2) according to an embodiment of the disclosure.

Referring to FIG. 6, in operation 601, the processor (e.g., the processor 120 in FIG. 1) of the electronic device 101 may receive an audio signal together with sound source location information of the audio signal from another electronic device (or a second electronic device) (e.g., the electronic device 102 or 104 in FIG. 1) through the communication circuit (e.g., the communication module 190 in FIG. 1). The electronic device 101 may receive the audio signal from the other electronic device (e.g., 102 or 104) in real time. The electronic device 101 may directly receive an audio signal from the other electronic device 102 or 104, or may receive the same through a server 108.

According to various embodiments, the electronic device 101 may be a portable and/or mobile electronic device, such as a smartphone, a tablet PC, a portable multimedia player (PMP), a personal digital assistant (PDA), a laptop PC, and a wearable device.

According to various embodiments, the other electronic device 102 or 104 may be a portable and/or mobile electronic device, such as a smartphone, a tablet PC, a portable multimedia player (PMP), a personal digital assistant (PDA), a laptop PC, and a wearable device. The other electronic device 102 or 104 may transmit audio data to the electronic device 101 while being connected thereto through a short-range communication network, such as Bluetooth (or BLE), Wi-Fi direct, or infrared data association (IrDA), or a long-range communication network, such as a legacy cellular network, a 5G network, a next-generation communication network, the Internet, or a computer network (e.g., a LAN or a WAN).

In operation 603, the processor 120 may identify head-related transfer function (HRTF) information of an individual user. For example, an user individual HRTF information may be stored in the memory 130.

In case that the user individual HRTF information cannot be identified, the processor 120 may generate the user individual HRTF information in operation 605. Operation 605 may be implemented to be performed in advance, and the generated user individual HRTF information may be stored in the memory 130.

The processor 120 may acquire user information, such as a user's nationality, age, gender, and information regarding a head or a face and/or cars of the user, from the memory 130. For example, the processor 120 may extract various pieces of information, such as depth information, from user face image data acquired through a camera (e.g., the camera module 180 in FIG. 1), and determine information regarding the user's face and/or ears, such as a face width of the user, a distance between both ears, and/or a position or shape of the ears, based on the extracted information.

According to an embodiment, the processor 120 may extract an individual user HRTF by comparing reference HRTF information with the user HRTF information stored in the HRTF database based on the acquired user information, and use the extracted HRTF as the user individual HRTF information.

According to an embodiment, the processor 120 may further correct the user individual HRTF extracted from the HRTF database and use the corrected HRTF as the user individual HRTF information. For example, the processor 120 may generate a designated diagnostic sound through its own speaker (e.g., the sound output module 155 in FIG. 1), receive diagnostic sound audio data by causing the generated diagnostic sound to be acquired through microphones of the first external electronic device 210 and the second external electronic device 220, and, based on user information, analyze the diagnostic sound audio data to derive HRTF information. The processor 120 may correct the user individual HRTF extracted from the HRTF database, based on the derived HRTF information, and use the corrected HRF as the user individual HRTF information.

In operation 607, the processor 120 may generate two pieces of audio data for generating the binaural sound on the left and right sides by applying the sound source location information to the received audio signal. For example, the processor 320 may reflect an interaural time difference (e.g., a frequency latency difference) and/or an interaural level difference (e.g., a decibel difference) according to a location of the sound source in audio data to be transmitted respectively to an external electronic device 300 (e.g., the first external electronic device 210 in FIG. 2) worn on a left ear of a user and to an external electronic device (e.g., the second external electronic device 220 in FIG. 2) worn on a right ear of the user. A method for reflecting the sound source location will be described in more detail with reference to FIGS. 7 to 10 below.

In operation 609, the processor 120 may perform signal processing on the input audio data by using the user individual HRTF information and generate personalized audio data. For example, the processor 120 may perform filtering on the input audio data, based on the user individual HRTF information, or perform other audio signal processing methods on the input audio data.

According to an embodiment, the user individual HRTF information may be expressed as matrix A in Equation 1 described above so as to reflect HRFT values for left and right audio data, and in this case, a filter for performing filtering may be expressed as matrix A as a function defined in Equation 1.

According to an embodiment, the user individual HRTF information may be converted to a time domain, for example, to generate an HRIR, and HRIRs for the left and right ears may be respectively applied to the input audio data to generate personalized audio data.

In operation 611, the processor 120 may transmit two pieces of audio data for generating a binaural sound to the first external electronic device 210 and the second external electronic device 220, which are external electronic devices 300, respectively through the communication circuit (e.g., the communication module 190 in FIG. 1) so that the audio data are reproduced. The first external electronic device 210 and the second external electronic device 220 may include a headphone, an earphone, and/or an earbud which may be worn on both sides of the user's ears, respectively.

Each of the first external electronic device 210 and the second external electronic device 220 may process corresponding left or right audio data among the binaural audio data received from the electronic device 101 and output the same through a speaker (e.g., the speaker 350 in FIG. 3). Accordingly, a user wearing the first external electronic device 210 and the second external electronic device 220 may enjoy a binaural sound in which the user's HRTF is applied to sound generated at a received sound source location, thereby providing an enhanced sense of presence.

FIG. 7 illustrates an operation of identifying or applying sound source location information of an electronic device (e.g., the electronic device 101 in FIG. 1 or 2) according to an embodiment of the disclosure.

Referring to FIG. 7, graph (a) of FIG. 7. may represent audio data acquired by a first external electronic device 210 worn on the left ear of a user, for example, and graph (b) of FIG. 7 may represent audio data acquired by a second external electronic device 220 worn on the right ear of the user, for example.

Referring to the drawings, a sound signal generated at a location of a sound source may experience a signal frequency latency depending on a distance to a position of the first external electronic device 210 or the second external electronic device 220, and a level of the signal may also change. Accordingly, a difference in signal frequency latency and/or a difference in signal level may exist between a first point 701 at which audio data is acquired by the first external electronic device 210 due to the sound signal generated at the sound source location and a second point 702 at which audio data is acquired by the second external electronic device 220. Based on the difference in signal frequency latency and/or the difference in signal level, a distance to the sound source from the external electronic device may be calculated.

According to an embodiment, the memory (e.g., the memory 130 in FIG. 1) of the electronic device 101 may store data for calculating a location of a sound source, based on a frequency latency difference and/or a signal level difference of the audio data respectively acquired from the first external electronic device 210 and the second external electronic device 220. For example, data for calculating the location of a sound source may include an HRTF database, and the HRTF database may include data for identifying sound source location information, for example, information regarding two pieces of audio data according to a distance and an angle to the sound source, such as information regarding a frequency latency difference and/or a signal level difference. The information on the two pieces of audio data included in the HRFT database may be, for example, information derived by applying a dummy head (e.g., a mannequin head shape).

According to an embodiment, the processor 120 of the electronic device 101 may identify a sound source location, based on two pieces of audio data, or may generate binaural audio data by applying the sound source location.

According to an embodiment, the processor 120 of the electronic device 101 may identify a location of the sound source, for example, a distance and a 360-degree azimuth, based on three or more pieces of audio data acquired simultaneously, for example, by using information regarding a frequency latency difference and/or a signal level difference of the audio data.

According to an embodiment, the processor 120 of the electronic device 101 may identify a location of the sound source, for example, a distance and a 360-degree azimuth, based on two pieces of audio data acquired simultaneously.

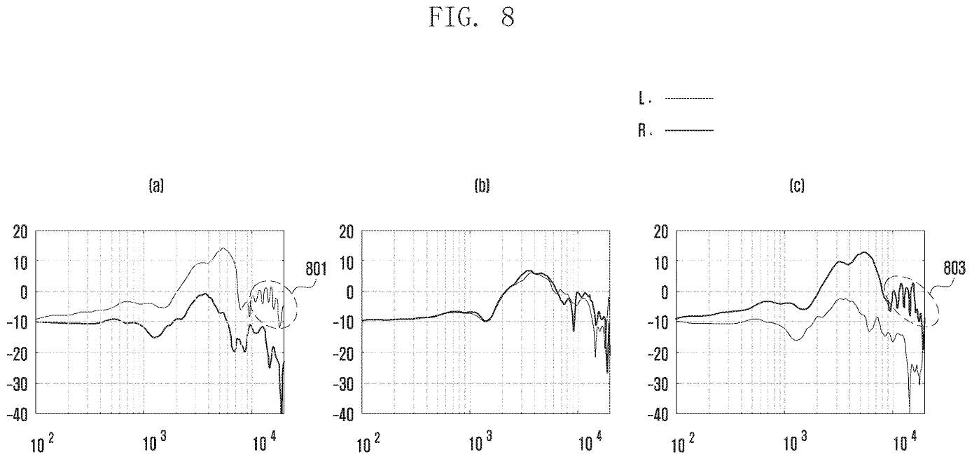

Hereinafter, a method for identifying a location of a sound source, based on two pieces of audio data, or generating two pieces of audio data by applying the sound source location, will be described with reference to FIGS. 8, 9, and 10. Hereinafter, the audio data acquired or reproduced by the first external electronic device (e.g., the first external electronic device 210 in FIG. 1) worn on the user's left ear may be referred to as first audio data or left audio data (L), and the audio data acquired or reproduced by the second external electronic device (e.g., the second external electronic device 220 in FIG. 1) worn on the user's right ear may be referred to as second audio data or right audio data (R).

FIGS. 8, 9, and 10 illustrate an operation of identifying or applying sound source location information in an electronic device according to various embodiments of the disclosure.

Referring to FIG. 8, graph (a) of FIG. 8 may indicate left audio data (L) and right audio data (R) in a case where, for example, a sound source location is 45 degrees to the front left (315 degrees in a 360-degree azimuth). Graph (b) of FIG. 8 may indicate left audio data (L) and right audio data (R) in a case where, for example, a sound source location is in front, that is, 0 degrees. Graph (c) of FIG. 8 may indicate left audio data (L) and right audio data (R) in a case where, for example, a sound source location is 45 degrees to the front right.

In graph (a) of FIG. 8, when the sound source location is 45 degrees to the front left (315 degrees in a 360-degree azimuth), the right audio data (R) has a relatively later audio data acquisition time due to frequency latency and a relatively lower level than the left audio data (L). Graph (b) of FIG. 8 illustrates a case where, for example, the sound source location is in front, that is, 0 degrees, and it may be seen that there is substantially no difference in frequency latency and level between the left audio data (L) and the right audio data (R). Graph (c) of FIG. 8 illustrates a case where, for example, the sound source location is 45 degrees (45 degrees) to the front right, it may be seen that the right audio data (R) has a relatively earlier audio data acquisition time due to frequency latency and a relatively higher level than the left audio data (L).

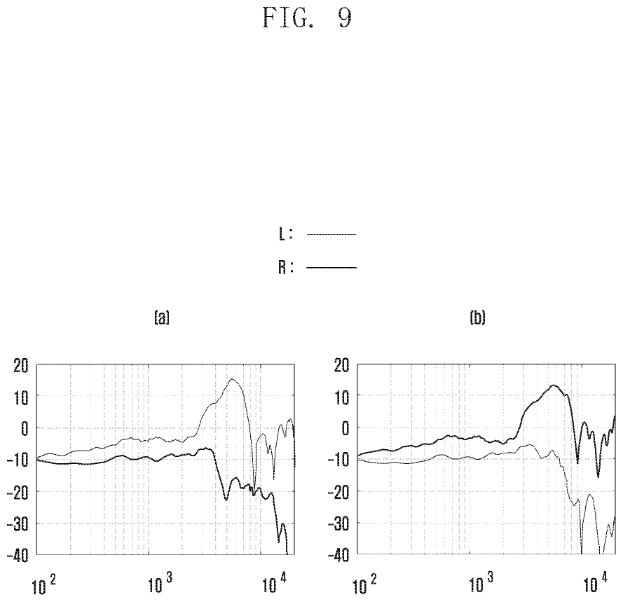

Referring to FIG. 9, graph (a) of FIG. 9 may indicate left audio data (L) and right audio data (R) in a case where, for example, the sound source location is 90 degrees to the left (270 degrees in a 360-degree azimuth). Graph (b) of FIG. 9 may indicate left audio data (L) and right audio data (R) in a case where a sound source location is 90 degrees to the right, for example.

In graph (a) of FIG. 9, for example, when the sound source location is 90 degrees to the left (270 degrees in a 360-degree azimuth), it may be seen that the right audio data (R) has a relatively later audio data acquisition time due to frequency latency and a relatively lower level than the left audio data (L). In graph (b) of FIG. 9, for example, when the sound source location is 90 degrees to the right, it may be seen that the right audio data (R) has a relatively earlier audio data acquisition time due to frequency latency and a relatively higher level than the left audio data (L).

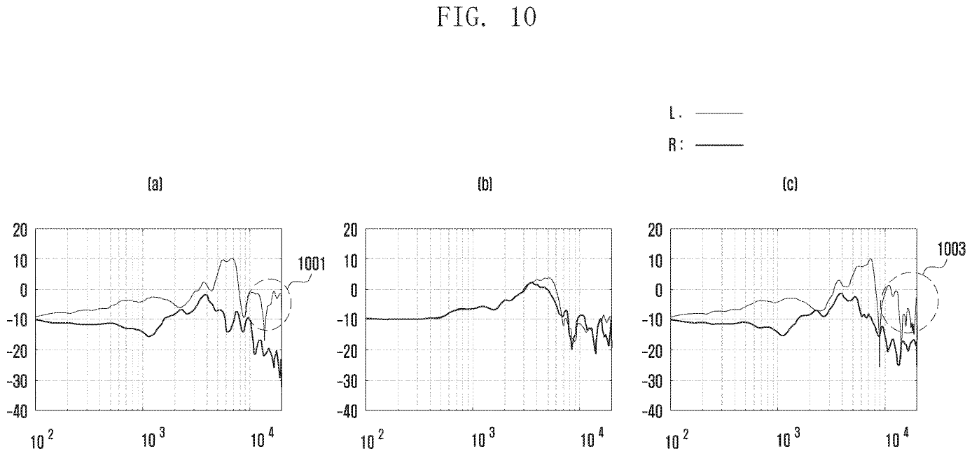

Referring to FIG. 10, graph (a) of FIG. 10 may indicate left audio data (L) and right audio data (R) in a case where, for example, the sound source location is 45 degrees to the rear left (225 degrees in a 360-degree azimuth). Graph (b) of FIG. 10 may indicate left audio data (L) and right audio data (R) in a case where, for example, the sound source location is directly to the rear, that is, 180 degrees. Graph (c) of FIG. 10 may indicate left audio data (L) and right audio data (R) in a case where, for example, the sound source location is 45 degrees to the rear right (135 degrees).

In graph (a) of FIG. 10, for example, in a case where the sound source location is 45 degrees to the rear left (225 degrees in a 360-degree azimuth), it may be seen that the right audio data (R) has a relatively later audio data acquisition time due to frequency latency and a relatively lower level than the left audio data (L). In graph (b) of FIG. 10, in a case where, for example, the sound source location is directly to the rear, that is, 180 degrees, it may be seen that there is substantially no difference in frequency latency and level between the left audio data (L) and the right audio data (R). In graph (c) of FIG. 10, in a case where, for example, a sound source location is 45 degrees to the rear right (135 degrees), the right audio data (R) has a relatively earlier audio data acquisition time due to frequency latency and a relatively higher level than the left audio data (L).

According to an embodiment, when comparing graph (a) in FIG. 8 with graph (a) in FIG. 10, it may be seen that a signal level intensity in a high-frequency region 801 of left audio data when a sound source location is 45 degrees to the front left is relatively higher than a signal level intensity in a high-frequency region 1001 of the left audio data when the sound source location is 45 degrees to the rear left. In addition, when comparing graph (c) in FIG. 8 with graph (c) in FIG. 10, it may be seen that a signal level intensity in a high-frequency region 803 of right audio data when a sound source location is 45 degrees to the front right is relatively higher than a signal level intensity in a high-frequency region 1003 of the right audio data when the sound source location is 45 degrees to the rear right. Accordingly, whether the sound source location is in front or to the rear may be identified based on a signal level intensity in a high-frequency region.

According to an embodiment, the memory (e.g., the memory 130 in FIG. 1) of the electronic device 101 may store data for calculating a location of a sound source, based on a frequency latency difference and/or a signal level of audio data respectively acquired from the first external electronic device 210 and the second external electronic device 220, and additionally based on a signal level difference in a high frequency region. For example, the data for calculating the location of the sound source may include an HRTF database, and the HRTF database may include data for identifying sound source location information, for example, information regarding two pieces of audio data according to a distance and an angle to the sound source, such as information regarding a frequency latency difference and/or a signal level difference, and additionally include information regarding a signal level difference in a high-frequency region. The information regarding the two pieces of audio data included in the HRTF database may be, for example, information calculated by applying a dummy head (e.g., a mannequin head shape).

According to an embodiment, the processor 120 of the electronic device 101 may identify a sound source location based on two pieces of audio data, or generate binaural audio data by applying the sound source location.

An electronic device (e.g., the electronic device 101 in FIG. 1) according to various embodiments may include a communication circuit (e.g., the communication module 190 in FIG. 1), memory (e.g., the memory 130 in FIG. 1), and a processor (e.g., the processor 120 in FIG. 1) operatively connected to the communication circuit and the memory. The memory may store instructions that, when executed by the processor, cause the electronic device to receive, through the communication circuit, two or more pieces of audio data simultaneously acquired by one or more external electronic devices (e.g., the external electronic devices 210, 220, and/or 300 in FIG. 2, FIG. 3, or 4), identify user individual head-related transfer function (HRTF) information obtained based on reference HRTF information by using user information acquired from the memory, identify sound source generation location information, based on the two or more pieces of audio data, generate an audio signal by performing inverse filtering on the two or more pieces of audio data, based on the user individual HRTF information, and transmit the audio signal and the sound source generation location information to another electronic device through the communication circuit.

According to an embodiment, the memory may further store instructions that, when executed by the processor, cause the electronic device to acquire sound source generation location information of the two or more pieces of audio data, based on at least one of a time difference or a level difference between the two or more pieces of audio data.

According to an embodiment, the memory may further store instructions that, when executed by the processor, cause the electronic device to receive three or more pieces of audio data acquired simultaneously by the one or more external electronic devices, and to acquire sound source generation location information of the three or more pieces of audio data, based on at least one of a time difference or a level difference among the three or more pieces of audio data.

According to an embodiment, the electronic device may further include an image sensor (e.g., the camera module 180 in FIG. 1). The memory may further store instructions that, when executed by the processor, cause the electronic device to acquire the user individual HRTF information by further using the user information acquired from the image of the user obtained through the image sensor.

According to an embodiment, the electronic device may further include a speaker (e.g., the sound output module 155 in FIG. 1). The memory may further store instructions that, when executed by the processor, cause the electronic device to generate a diagnostic sound through the speaker, receive two or more pieces of diagnostic sound audio data generated by the one or more external electronic devices in response to the generation of the diagnostic sound, analyze the diagnostic sound audio data by using the user information to generate HRTF information, and correct the user individual HRTF information by using the generated HRTF information.

According to an embodiment, the user information may include at least one of nationality, age, gender, head size, and ear shape information of the user, and the memory may further store instructions that, when executed by the processor, cause the electronic device to acquire the reference HRTF information from the memory by using the user information, and to acquire the user individual HRTF information, based on the reference HRTF information.

According to an embodiment, the memory may further store instructions that, when executed by the processor, cause the electronic device to represent the user HRFT information as a matrix, and perform the inverse filtering by applying an inverse matrix thereof to the two or more pieces of audio data.

According to an embodiment, A method of an electronic device may include receiving two or more pieces of audio data simultaneously acquired by one or more external electronic devices, identifying user individual head-related transfer function (HRTF) information obtained based on reference HRTF information by using user information, identifying sound source generation location information of the two or more pieces of audio data, based on the two or more pieces of audio data, generating an audio signal by performing, based on the user individual HRTF information, inverse filtering on the two or more pieces of audio data, and transmitting the audio signal and the sound source generation location information to another electronic device.

According to an embodiment, the method may further include, based on at least one of a time difference or a level difference between the two or more pieces of audio data, acquiring sound source generation location information of the two or more pieces of audio data.

According to an embodiment, the method may further include receiving three or more pieces of audio data simultaneously acquired by the one or more external electronic devices, and acquiring sound source generation location information of the three or more pieces of audio data, based on a time difference or a level difference among the three or more pieces of audio data.

According to an embodiment, the method may further include acquiring the reference HRTF information from the memory by using the user information, and acquiring the user individual HRTF information, based on the reference HRTF information, and the user information includes at least one of nationality, age, gender, head size, and ear shape information of a user.

According to an embodiment, the method may further include representing the user individual HRFT information as a matrix, and performing the inverse filtering by applying an inverse matrix thereof to the two or more pieces of audio data.

According to an embodiment, an electronic device (e.g., the electronic device 101 in FIG. 1) may include a communication circuit (e.g., the communication module 190 in FIG. 1), memory (e.g., the memory 130 in FIG. 1), and a processor (e.g., the processor 120 in FIG. 1) operatively connected to the communication circuit and the memory. The memory may store instructions that, when executed by the processor, cause the electronic device to receive a binaural audio signal and location information of an audio source of the audio signal from another electronic device through the communication circuit, identify user individual head-related transfer function (HRTF) information obtained based on reference HRTF information by using user information acquired from the memory, generate two pieces of audio data by applying the user individual HRTF information and the location information to the audio signal, and transmit the two pieces of audio data to one or more external electronic devices such that the two pieces of audio data are reproduced by the one or more external electronic devices.

According to an embodiment, the electronic device may further include an image sensor (e.g., the camera module 180 in FIG. 1), and the memory may further store instructions that, when executed by the processor, cause the electronic device to acquire the user individual HRTF information by further using the user information acquired from an image of the user obtained through the image sensor.

According to an embodiment, the electronic device may further include a speaker (e.g., the sound output module 155 in FIG. 1), and the memory may further store instructions that, when executed by the processor, cause the electronic device to generate a diagnostic sound through the speaker, receive two or more pieces of diagnostic sound audio data generated by the one or more external electronic devices in response to the generation of the diagnostic sound, generate HRTF information by analyzing the diagnostic sound audio data by using the user information, and correct the user individual HRTF information by using the generated HRTF information.

According to an embodiment, the user information may include at least one of the user's nationality, age, gender, head size, and ear shape information, and the memory may further store instructions that, when executed by the processor, cause the electronic device to acquire the reference HRTF information from the memory by using the user information, and to acquire the user HRTF information, based on the reference HRTF information.

According to an embodiment, the memory may further store instructions that, when executed by the processor, cause the electronic device to represent the user HRFT information as a matrix, and acquire the two pieces of audio data by applying the matrix and the location information to the audio signal.

According to an embodiment, A method of an electronic device may include receiving, through a communication circuit, a binaural audio signal and location information of the audio signal from another electronic device, identifying user individual head-related transfer function (HRTF) information obtained based on reference HRTF information by using user information acquired from the memory, generating two pieces of audio data by applying the user individual HRTF information and the location information to the audio signal, and transmitting the two pieces of audio data to one or more external electronic devices such that the two pieces of audio data are reproduced by the one or more external electronic devices.

According to an embodiment, the user information may include at least one of the user's nationality, age, gender, head size, and ear shape information, and the method may further include acquiring the reference HRTF information by using the user information, and acquiring the user HRTF information, based on the reference HRTF information.

According to an embodiment, the method may further include representing the user HRFT information as a matrix, and acquiring the two pieces of audio data by applying the matrix and the location information to the audio signal. An electronic device according to various embodiments disclosed herein may be any of various types of devices. The electronic device may include, for example, a portable communication device (e.g., a smartphone), a computer device, a portable multimedia device, a portable medical device, a camera, a wearable device, or a home appliance. The electronic device according to the embodiments of the disclosure is not limited to those described above.

It is to be understood that various embodiments of the disclosure and terms for describing the embodiments are not intended to limit the technical features disclosed herein to specific embodiments, and that the embodiments include various modifications, equivalents, or substitutions of the corresponding embodiments. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Such terms as “a first”, “a second”, “the first”, and “the second” may be used to simply distinguish a corresponding element from another, and does not limit the elements in other aspect (e.g., importance or order). When a certain (e.g., a first) component is mentioned as being “coupled” or “connected” to another (e.g., a second) component, with or without a term “functionally” or “communicatively,” it means that the certain component may be connected to the other component directly (e.g., wiredly), wirelessly, or via a third component.

The term “module” used in various embodiments of the disclosure may include a unit implemented in hardware, software, or firmware, and may be used interchangeably with terms such as “logic,” “logic block,” “component,” “circuit,” or the like. The module may be an integrally configured component or a minimum unit or a portion of the component, which performs one or more functions. For example, according to an embodiment, the module may be implemented in the form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include codes generated by a compiler or code capable of being executed by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments set forth herein may be included and provided in a computer program product. The computer program product may be traded as a product between a seller and a purchaser. The computer program product may be distributed in the form of a machine-readable storage medium (e.g., compact disc read-only memory (CD-ROM)), or may be directly distributed through an application store (e.g., Play Store™) or directly between two user devices (e.g., smartphones), or may be distributed online (e.g., downloaded or uploaded). If distributed online, at least part of the computer program product may be temporarily generated or at least temporarily stored in the machine-readable storage medium, such as memory of the manufacturer's server, a server of the application store, or a relay server.

According to various embodiments, each of the above-described components (e.g., module or program) may include either a single entity or multiple entities, and some of the multiple entities may be placed separately from other components. According to various embodiments, one or more of the above-described components may be omitted, or one or more other components may be added. Alternatively or additionally, multiple components (e.g., modules or programs) may be integrated into a single component. In such a case, the integrated component may perform one or more functions of each of the multiple components in the same or a similar manner as performed by the corresponding one of the multiple components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuit;
memory, comprising one or more storage media, storing instructions; and
one or more processors communicatively coupled to the communication circuit and the memory,
wherein the instructions, when executed by the one or more processors individually or collectively, cause the electronic device to:
receive, through the communication circuit, two or more pieces of audio data simultaneously acquired by one or more external electronic devices,
identify user individual head-related transfer function (HRTF) information acquired based on reference HRTF information by using user information acquired from the memory,
based on the two or more pieces of audio data, identify sound source generation location information of the two or more pieces of audio data,
generate an audio signal by performing inverse filtering of the two or more pieces of audio data, based on the user individual HRTF information, and
transmit the audio signal and the sound source generation location information to another electronic device through the communication circuit.

2. The electronic device of claim 1, wherein the instructions, when executed by the one or more processors, further cause the electronic device to acquire sound source generation location information of the two or more pieces of audio data, based on at least one of a time difference or a level difference between the two or more pieces of audio data.

3. The electronic device of claim 1, wherein the instructions, when executed by the one or more processors, further cause the electronic device to:
receive three or more pieces of audio data simultaneously acquired by the one or more external electronic devices; and
acquire sound source generation location information of the three or more pieces of audio data, based on at least one of a time difference or a level difference among the three or more pieces of audio data.

4. The electronic device of claim 1, further comprising:
an image sensor,
wherein the instructions, when executed by the one or more processors, further cause the electronic device to acquire the user individual HRTF information by further using user information acquired from a user's image acquired through the image sensor.

5. The electronic device of claim 1, further comprising:
a speaker,
wherein the instructions, when executed by the one or more processors, further cause the electronic device to:
generate a diagnostic sound through the speaker,
receive two or more pieces of diagnostic sound audio data generated by the one or more external electronic devices in response to generation of the diagnostic sound, and
analyze the diagnostic sound audio data by using the user information to generate HRTF information, and correct the user individual HRTF information by using the generated HRTF information.

6. The electronic device of claim 1,
wherein the user information includes at least one of nationality, age, gender, head size, and ear shape information of a user, and
wherein the instructions, when executed by the one or more processors, further cause the electronic device to acquire the reference HRTF information from the memory by using the user information, and based thereon, acquire the user individual HRTF information.

7. The electronic device of claim 1, wherein the instructions, when executed by the one or more processors, further cause the electronic device to represent the user individual HRTF information as a matrix, and perform the inverse filtering by applying an inverse matrix of the matrix to the two or more pieces of audio data.

8. A method performed by an electronic device, the method comprising:
receiving, by the electronic device, two or more pieces of audio data simultaneously acquired by one or more external electronic devices;
identifying, by the electronic device, user individual head-related transfer function (HRTF) information acquired based on reference HRTF information by using user information;
based on the two or more pieces of audio data, identifying, by the electronic device, sound source generation location information of the two or more pieces of audio data;
generating, by the electronic device, an audio signal by performing inverse filtering of the two or more pieces of audio data, based on the user individual HRTF information; and
transmitting, by the electronic device, the audio signal and the sound source generation location information to another electronic device.

9. The method of claim 8, further comprising acquiring sound source generation location information of the two or more pieces of audio data, based on at least one of a time difference or a level difference between the two or more pieces of audio data.

10. The method of claim 8, further comprising:
receiving three or more pieces of audio data simultaneously acquired by the one or more external electronic devices; and
acquiring sound source generation location information of the three or more pieces of audio data, based on at least one of a time difference or a level difference among the three or more pieces of audio data.

11. The method of claim 8,
wherein the user information includes at least one of nationality, age, gender, head size, and ear shape information of a user, and
wherein the method further comprises acquiring the reference HRTF information from memory by using the user information, and acquiring the user individual HRTF information, based on the reference HRTF information.

12. The method of claim 8, further comprising:
representing the user individual HRTF information as a matrix; and
performing the inverse filtering by applying an inverse matrix of the matrix to the two or more pieces of audio data.

13. The method of claim 8, further comprising:
acquiring the user individual HRTF information by further using user information acquired from a user's image acquired through an image sensor.

14. The method of claim 8, further comprising:
generating a diagnostic sound through a speaker;
receiving two or more pieces of diagnostic sound audio data generated by the one or more external electronic devices in response to generation of the diagnostic sound; and
analyzing the diagnostic sound audio data by using the user information to generate HRTF information, and correcting the user individual HRTF information by using the generated HRTF information.

15. An electronic device comprising:
a communication circuit;
memory, comprising one or more storage media, storing instructions; and
one or more processors communicatively coupled to the communication circuit and the memory,
wherein the instructions, when executed by the one or more processors individually or collectively, cause the electronic device to:
receive, through the communication circuit, a binaural audio signal and sound source generation location information of the binaural audio signal from another electronic device,
identify user individual head-related transfer function (HRTF) information acquired based on reference HRTF information by using user information acquired from the memory,
generate two pieces of audio data by applying the user individual HRTF information and the sound source generation location information to the binaural audio signal, and
transmit the two pieces of audio data to one or more external electronic devices so as to reproduce the two pieces of audio data by the one or more external electronic devices.

16. The electronic device of claim 15, further comprising:
an image sensor,
wherein the instructions, when executed by the one or more processors, further cause the electronic device to acquire the user individual HRTF information by further using user information acquired from a user's image acquired through the image sensor.

17. The electronic device of claim 15, further comprising:
a speaker,
wherein the instructions, when executed by the one or more processors, further cause the electronic device to:
generate a diagnostic sound through the speaker,
receive two or more pieces of diagnostic sound audio data generated by the one or more external electronic devices in response to generation of the diagnostic sound, and
analyze the diagnostic sound audio data by using the user information to generate HRTF information, and correct the user individual HRTF information by using the generated HRTF information.

18. One or more non-transitory computer-readable storage media storing one or more computer programs including computer-executable instructions that, when executed by one or more processors of an electronic device individually or collectively, cause the electronic device to perform operations, the operations comprising:
receiving, by the electronic device, two or more pieces of audio data simultaneously acquired by one or more external electronic devices;
identifying, by the electronic device, user individual head-related transfer function (HRTF) information acquired based on reference HRTF information by using user information;
based on the two or more pieces of audio data, identifying, by the electronic device, sound source generation location information of the two or more pieces of audio data;
generating, by the electronic device, an audio signal by performing inverse filtering of the two or more pieces of audio data, based on the user individual HRTF information; and
transmitting, by the electronic device, the audio signal and the sound source generation location information to another electronic device.

19. The one or more non-transitory computer-readable storage media of claim 18, the operations further comprising acquiring sound source generation location information of the two or more pieces of audio data, based on at least one of a time difference or a level difference between the two or more pieces of audio data.

20. The one or more non-transitory computer-readable storage media of claim 18, the operations further comprising:
receiving three or more pieces of audio data simultaneously acquired by the one or more external electronic devices; and
acquiring sound source generation location information of the three or more pieces of audio data, based on at least one of a time difference or a level difference among the three or more pieces of audio data.
